(19) United States
(12) Patent Application Publication
(10) Pub. No.: US 2020/0216295 A1
(43) Pub. Date: Jul. 9, 2020

(54) Stirrup Hoist Systems and Methods for Hoisting a Person onto a Horse

(71) Applicant: David L. Coffman, Cle Elum, WA (US)

(72) Inventors: David L. Coffman, Cle Elum, WA (US); Philip A. Pintor, Spokane, WA (US)

(73) Assignee: David L. Coffman, Cle Elum, WA (US)

(21) Appl. No.: 16/733,389

(22) Filed: Jan. 3, 2020

Related U.S. Application Data
(60) Provisional application No. 62/788,020, filed on Jan. 3, 2019.

(51) Int. Cl. B66D 1/12; B68C 3/00; B66D 1/30; B66D 1/46

(52) U.S. Cl. CPC B66D 1/12; B68C 3/0016; B66D 2700/025; B66D 1/46; B66D 1/30

(57) ABSTRACT

A stirrup hoist system for hoisting a person onto a saddle includes a motor and a spool configured to be rotated by the motor. A strap is configured to be selectively rolled on, and selectively rolled off, the spool. A support configured to receive a portion of a person's body and slidingly engages the strap. The support selectively moves toward the spool, and selectively moves away from, the spool.

### RELATED PATENT DATA

This application resulted from a provisional U.S. Patent Application Ser. No. 62/788,020, filed Jan. 3, 2019, which is incorporated herein by reference.

### TECHNICAL FIELD

Stirrup hoist systems and methods for hoisting a person onto a horse.

### BACKGROUND

The strength in a person's legs diminishes as the person ages. The loss of strength in the legs continues until the person is prevented from enjoying personal physical activities that require a certain level of strength in the legs. Personal physical activities include lifting oneself onto a horse, a boat, and a truck. More importantly, loss of strength in the legs can affect a person's health. Consider a person who cannot get out of bed, off a toilet and even out of a chair. Still further, what about the elderly, children and handicapped people with physical deficiencies in the legs. Such elderly and handicapped people may have never had the opportunity to enjoy physical activities such as riding a horse or boat due to the leg problems. Moreover, the elderly and handicapped people need assistance to get out of bed, off a toilet and even out of a chair

As an example, consider one common physical activity enjoyed by a large number of the populace, riding horses. Riding horses is a passion for many people. People ride horses for numerous reasons: practical working purposes such as police work or herding animals; in competitive sports such as rodeo, show jumping, racing and polo; recreationally such as fox hunting and trail riding. The enjoyment and therapeutic aspects of riding horses are well documented. However, mounting a horse is difficult and requires strength in the legs. As we age and leg strength diminishes, mounting a horse becomes difficult until ultimately the task is impossible. Being unable to mount a horse is the most common factor for people to give up their passion to ride a horse.

Consequently, there is a great need to develop systems and methods that overcome the necessity of leg strength for a person to engage and enjoy numerous activities that require a particular level of leg strength.

### DRAWINGS

Embodiments of the disclosure are described below with reference to the following accompanying drawings.

FIG. 1 is a perspective view of the inventive system according to an embodiment of the invention;

FIG. 2 is a close-up partial-perspective view of the inventive system in an environment of use;

FIG. 3 is a partial perspective view of an exemplary preparation of use for the inventive system according to an embodiment of the invention;

FIG. 4 is a partial perspective view of an exemplary preparation of use for the inventive system subsequent to the FIG. 3 view;

FIG. 5 is a partial perspective view of an exemplary preparation of use for the inventive system subsequent to the FIG. 4 view;

FIG. 6 is a view of the inventive system in an environment of use according to an embodiment of the invention;

FIG. 7 is the FIG. 6 view of the inventive system in another of stage of use according to an embodiment of the invention;

FIG. 8 is a partial break-away front view of the inventive system;

FIG. 9 is side view of the inventive system;

FIG. 10 is side view, opposite of the FIG. 9 view, of the inventive system;

FIG. 11 is a sectional side view of the inventive system;

FIG. 12 is an exploded perspective view of an exemplary component of the inventive system;

FIG. 13 is a perspective view of an exemplary component of the inventive system;

FIG. 14 is a front view of the FIG. 13 component;

FIG. 15 is a side view of the FIG. 13 component;

FIG. 16 is a block diagram of the inventive system according to an embodiment of the invention;

FIG. 17 is a block diagram of the inventive system according to another embodiment of the invention;

FIG. 18 is a block diagram of the inventive system according to another embodiment of the invention; and

FIG. 19 is a block diagram of the inventive system according to another embodiment of the invention.

### DESCRIPTION

This disclosure is submitted in furtherance of the constitutional purposes of the U.S. Patent Laws “to promote the progress of science and useful arts” (Article 1, Section 8).

Again considering the horse application, there are several issues that need to be addressed to provide a person the capability to overcome the necessity of leg strength for engaging and enjoying riding a horse.

For example, the stirrup hoist system needs to be easily mounted to a saddle and travel with the horse. The configuration of the stirrup hoist system needs to permit the rider, at any time or location, to mount and dismount without encumbering the horse or rider. Similarly, there is a need for a stirrup hoist system that will not provide false commands to the horse nor spook the horse. Still further, the configuration of the stirrup hoist system needs to be small enough to fit in the tight area between the stirrup and the girth of the horse and yet provide the power necessary to lift a person. Additionally, there is a need for a stirrup hoist system to be configured with a wireless control since wires will be susceptible to damage and impede rider activities. Finally, there is a need for a stirrup hoist system to automatically stop operation in the uppermost position or when the travel mechanism is detrimentally locked up (bound up) to prevent the system/machinery from being damaged.

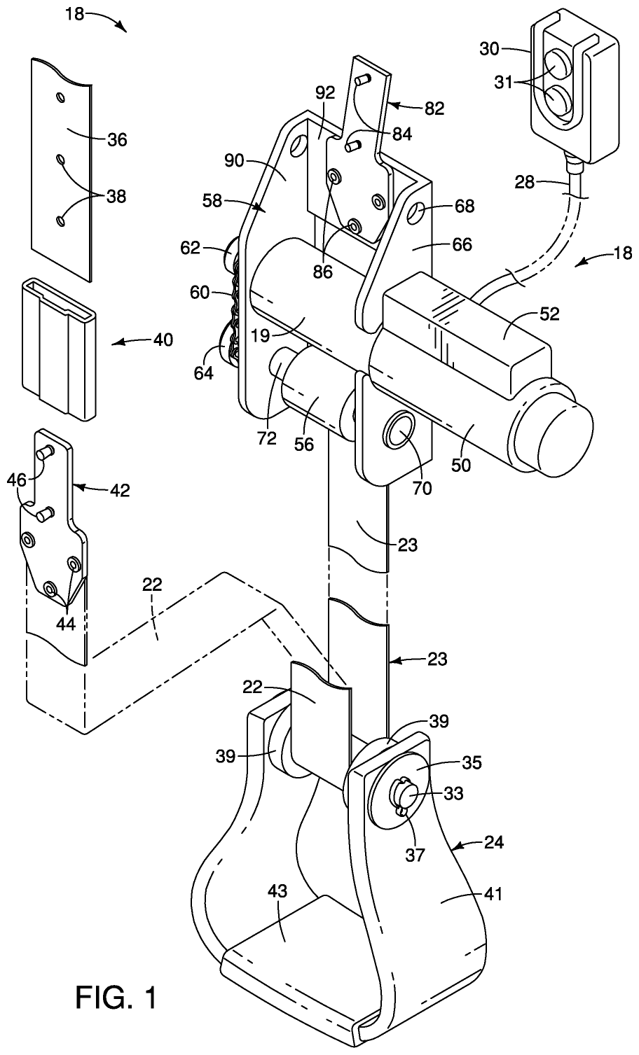

Referring to FIG. 1, an exemplary hoist system 18 is illustrated according to one embodiment of the invention. It should be understood that in one embodiment of the invention, the hoist system 18 is ultimately secured to a saddle 12 described more thoroughly subsequently. As a quick overview, the hoist system 18 includes a frame 58 that supports a power supply 52, motor 50, drive and/or gear assembly 19 coupled to a spool 72, and one end of a strap 22/23 secured to the spool 72. The strap 22/23 (a front portion is referenced as 22 and a rear portion is referenced as 23) is ultimately wrapped under and partially around a pivot pin 33 of a stirrup 24 of the saddle 12. It should be understood that a stirrup 24 may, or may not, be included as a component of the hoist system 18.

It should be understood that the stirrup 24 is a type of support for the hoist system 18 which is supporting a portion of a person's body, in this case, a foot. However, the stirrup can be replaced by other types of supports configured to receive a portion of a person's body. For example, the support can comprise one of the following: a shoe; a boot; a stirrup; a seat. Some of the different types of supports correspond to different types of methods of uses of the hoist system 18.

In one embodiment of the hoist system 18, an exemplary power supply 52 is a battery 52 supported upon the motor 50 and an exemplary motor 50 is an electric motor 50. Furthermore, in one embodiment of the invention, an exemplary battery 52 is a lithium battery 52 and has a voltage range of 12 volts to 48 volts. In one embodiment of the invention, an exemplary electric motor 50 includes a braking system that provides braking to the electric motor 50. An exemplary braking system for the electric motor 50 is a DC injection braking system or a dynamic braking system. In one embodiment of the invention, the drive assembly 19 includes a gear system. In one embodiment, the assembly 19 does not include a gear system. In one embodiment, the assembly 19 is a worm drive that includes a worm gear.

Still referring to FIG. 1, hoist system 18 has a first billet plate (first attachment plate) 82 secured to a cross section 92 of frame 58 by a plurality of rivets 86. Cross section 92 extends between opposite sides 66 and 90 of frame 58. A front surface of an upper portion of the first billet plate 82 has two vertically spaced pins 84 extending outwardly. Ultimately, the pins 84 of first billet plate 82 will be received in corresponding openings in saddle 12 described subsequently. The battery 52 and motor 50 are supported upon frame 58 laterally outward of, and adjacent to, side 66 of frame 58. Side 66 of frame 58 has an opening 68 above the battery 52 and motor 50. In one embodiment, the battery 52 is supported directly upon the motor 50. However, the battery 52 can be supported or secured elsewhere, including directly on the frame 58 or saddle 12.

Still referring to FIG. 1, the motor 50 is coupled to the drive assembly 19 wherein the drive assembly 19 is supported between sides 66 and 90 of frame 58. A first sprocket or timing belt pulley 62 is positioned outwardly of side 90 of frame 58 and establishes the terminal end of drive assembly 19. A drive (or transmission) chain or timing belt 60 extends over the first sprocket or timing belt pulley 62 and over a second sprocket or pulley 64 (each sprocket or timing belt pulley 62/64 can be referred to as a gearwheel or cogwheel). Second sprocket or timing belt pulley 64 is coupled to, and establishes a terminal end of, the spool 72 supported between sides 66 and 90 of frame 58 below the drive assembly 19. Another terminal end 70 of spool 72 is exposed from side 66 of frame 58. Between sides 66 and 90, the spool 72 has a roll 56 which is a segment of the rear portion 23 of strap 22/23.

Still referring to FIG. 1, as stated previously, strap 22/23 is wrapped under and partially around the pivot pin 33 of stirrup 24. Stirrup 24 includes tread wear leather 43, a pair of side pieces 41, and the pivot pin (bolt) 33. The pivot pin 33 is secured between the side pieces 41 with a washer 35 and cotter pin or snap ring 37. Spacers 39 on pivot pin 33 keeps strap 22/23 centered on the pivot pin 33. A terminal end of the front portion 22 of strap 22/23 is secured to a second billet plate (second attachment plate) 42 by a plurality of rivets 44. A front surface of an upper portion of the second billet plate 42 has two spaced pins 46 extending outwardly. The two pins 46 are to be received in two openings 38 of a front billet strap 36 (only partially shown) of saddle 12, Ultimately, a clamp 40 is slid over front billet strap 36 and over the two pins 46 of the second billet plate 42 to secure the terminal end of the front portion 22 of strap 22/23 to the front billet strap 36 of saddle 12. In this matter, the front portion 22 of strap 22/23 is secured to saddle 12.

Still referring to FIG. 1, the hoist system 18 includes a controller 30 and an electrical conduit 28 that extends between the motor 50 and controller 30. It should be understood that the controller 30 is used to selectively activate motor 50 and rotate spool 72. In one embodiment, controller 30 has two buttons 31 wherein one button will drive the spool 72 in one rotation direction and the other button will drive the spool 72 in the opposite rotation direction. In other embodiments, the controller 30, or the motor 50 alone, can be activated by a wireless remote control with a small fob.

It should be further understood that one rotation direction of spool 72 unwinds the roll 56 of strap 22/23 from the spool 72 to extend the strap 22/23. It should be further understood that the opposite rotation direction of spool 72 winds the roll 56 of strap 22/23 onto the spool 72 to draw up the strap 22/23. In one embodiment, controller 30 is pendant style push-button enclosure with a pair of up and down buttons. This embodiment of the controller 30 has relays, diodes and wiring self-contained within the push-button enclosure without a need for a secondary control enclosure.

Referring to FIG. 2, the hoist system 18 is shown secured to the saddle 12 and the saddle 12 is shown secured on a partially illustrated horse 14. A fender 16 and a stirrup leather 32 of the saddle 12 are shown in phantom to more efficiently illustrate the cooperation of the hoist system 18 with the saddle 12. In one non-limiting embodiment only, the opening 68 of frame 58 is shown having received a saddle string (lanyard) 20 of saddle 12 which stabilizes and levels the orientation of the hoist system 18. A rear billet strap 100 of saddle 12 receives the pins 84 of first billet plate 82. A clamp 102 slides over the rear billet strap 100 and pins 84 of first billet plate 82. In this matter, the frame 58 of the hoist system 18 is secured to saddle 12. Clamp 102 may, or may not, be the same configuration as clamp 40. In one embodiment, one or both of clamps 40 and 102 are configured as clips.

Still referring to FIG. 2 and as stated previously, strap 22/23 is provided under and around the pivot pin 33 of stirrup 24 with front portion 22 secured to the front billet strap 36. In this manner, and corresponding with the two rotation directions of the spool 72 previously discussed, the stirrup 24 selectively moves in an upward (raised, hoisted) direction 26, and alternatively in a downward direction 34, as the strap 22/23 retracts and extends, respectively.

In FIG. 2, stirrup 24 is shown in an extended position ready for a person to place a foot in the stirrup 24. Subsequently, the motor 50 is activated to retract strap 22/23 and move stirrup 24 in the upward direction 26 while the foot remains in the stirrup 24 to hoist (lift) the person upward. In one embodiment of the invention, the controller 30 is placed in a pouch 15 which is received over a horn 17 of the saddle 12 for easy access by a person. In other embodiments, the controller 30 can be placed or secured to other sections of the saddle 12 or directly on other structure of the hoist system 18.

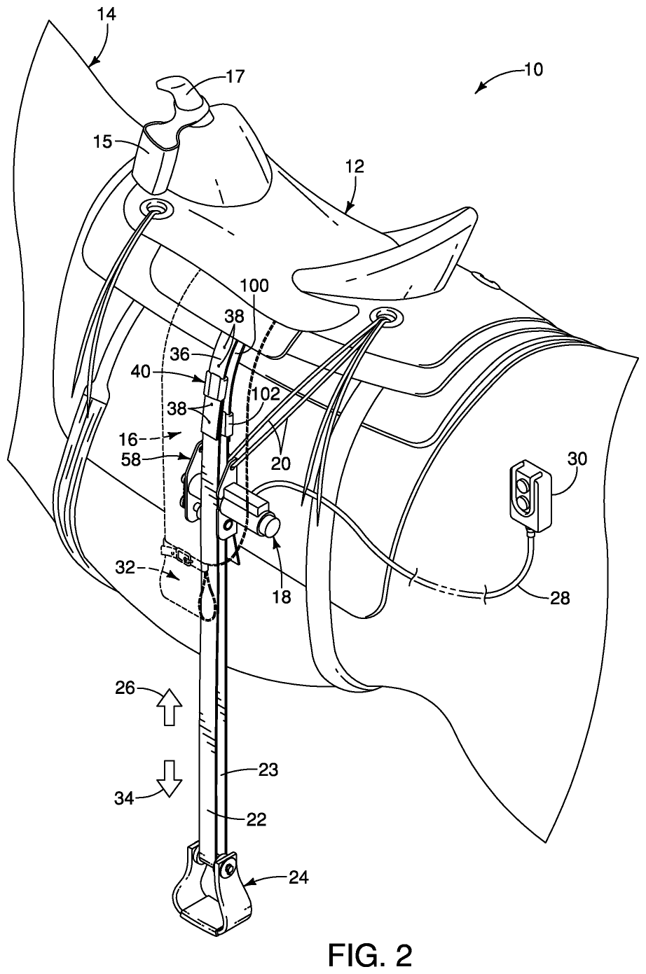

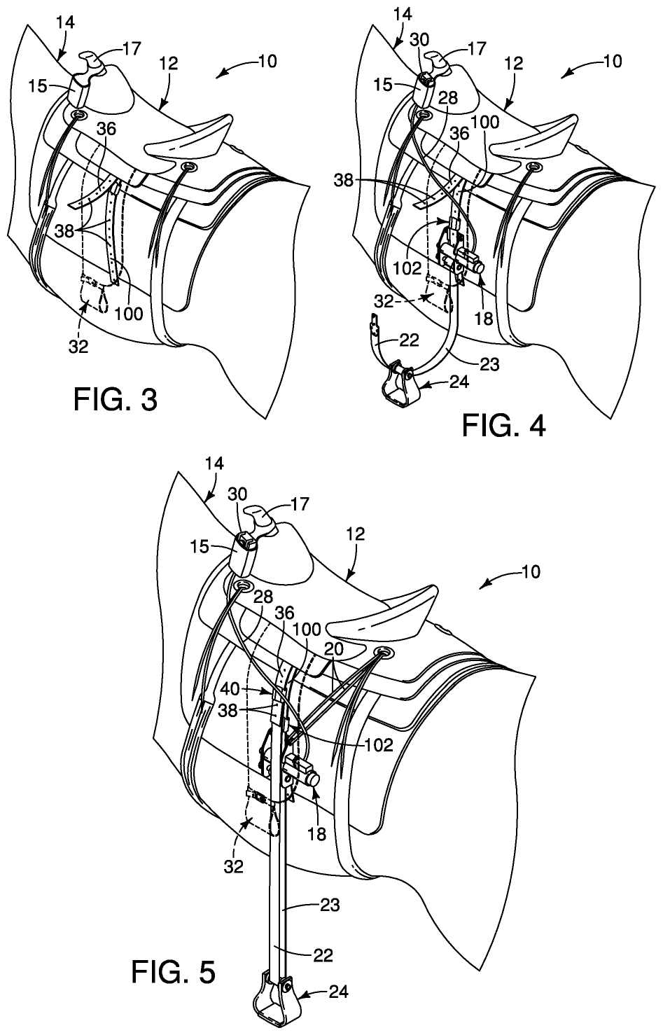

Referring to FIGS. 3-5, a method of securing hoist system 18 to saddle 12 is illustrated and described. Referring to FIG. 3, front and rear billet straps 36 and 100 are located on the saddle 12. Referring to FIG. 4, the frame 58 of hoist system 18 is secured to saddle 12 by attaching first billet plate 82 to the rear billet strap 100. Controller 30 is placed in pouch 15. A front portion 22 of strap 22/23 with the second billet plate 42 is positioned through stirrup 24 under and around pivot pin 33. Referring to FIG. 5, the second billet plate 42 of the front portion 22 of strap 22/23 is secured to the front billet strap 36 of saddle 12. In FIG. 5, stirrup 24 is in the extended position adjacent the ground to receive a foot.

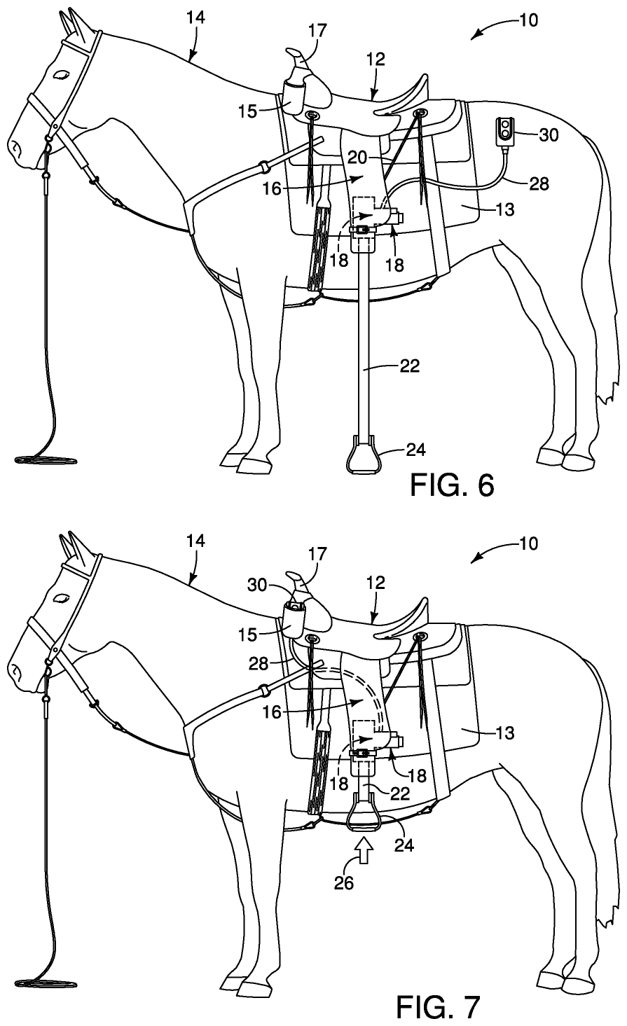

Referring to FIGS. 6 and 7, the hoist system 18 is illustrated already secured to the saddle 12 and the saddle 12 is already shown placed on the horse 14. As stated previously, a substantial portion of the hoist system 18 is located under the fender 16 of the saddle 12 against or adjacent the skirt 13 (or blanket). In one exemplary non-limiting embodiment of the invention, the electrical conduit 28 extends from beneath the fender 16 to the controller 30 and the controller is provided in the patch 15. In one embodiment of the invention, the strap 22/23 is a high-strength nylon belt. It should be understood that any hoist system disclosed in this document can be provided on either side of the horse with minimal or no saddle modifications.

Referring to FIG. 6, the hoist system 18 is illustrated having the strap 22/23 positioned in the extended position with the stirrup 24 ready to receive the foot (boot) of a person. Referring to FIG. 7, once a foot is placed in the strap 22/23 (not shown), the hoist system 18 is activated so that stirrup 24 travels in the upward direction 26 to rest in a final position. During the retracting of the stirrup 24 with the foot, the person is hoisted (lifted) upwardly until the person can easily swing the free leg over the saddle 14 and sit in the saddle 14. Any final position of the stirrup 24 can be selected depending on the comfort level of the person using the hoist system 18.

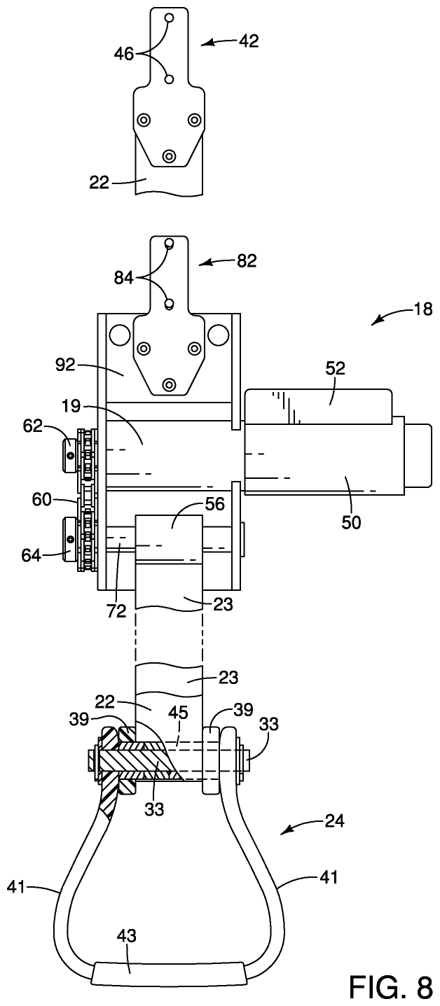

Referring to FIG. 8, a break-away view of stirrup 24 is illustrated to demonstrate that pivot pin 33 includes at least one bearing 45 rotatably secured on pivot pin 33. In one embodiment, two or more (a plurality) of discrete bearings 45 are rotatably secured over the pivot pin 33 between sides 41. The bearing(s) 45 facilitate the movement of the strap 22/23 around the pivot pin 33 of the stirrup 24 during the raising (drawing up), and alternatively lowering (releasing), of the strap 22/23 from the spool 72 of the hoist system 18. In one embodiment, the one or more bearing(s) 45 are roller bearings.

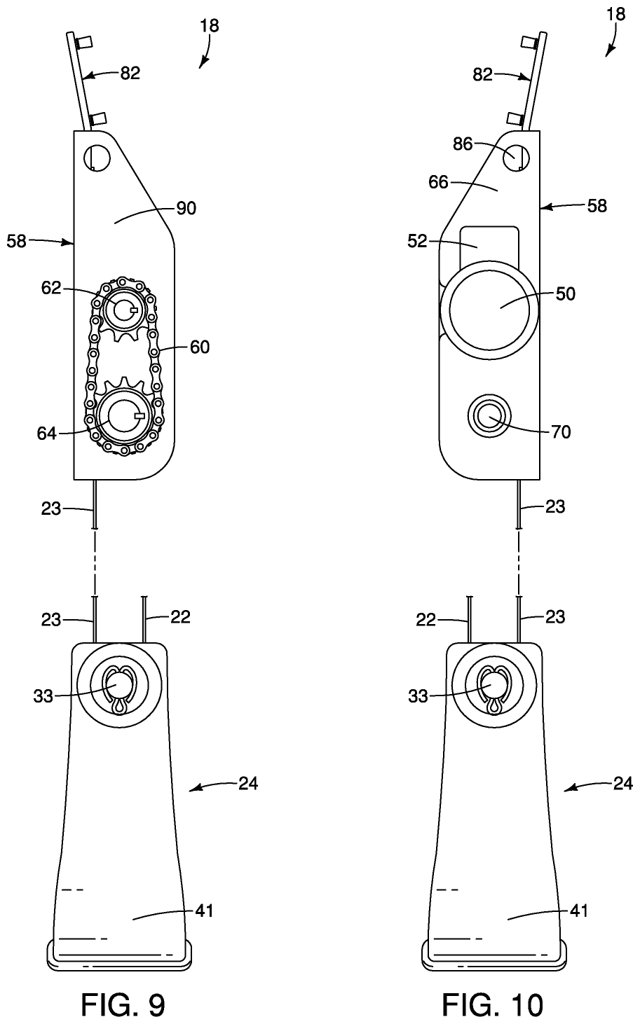

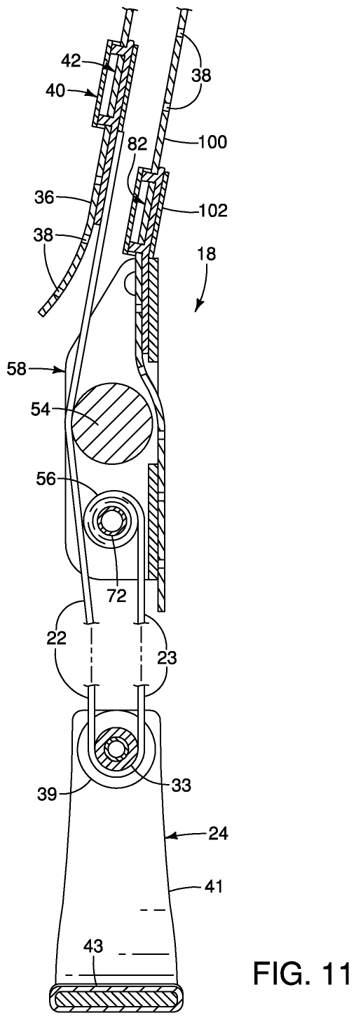

Referring to FIGS. 9-11, side views of hoist system 18 illustrate how narrow the structure is which minimizes the weight and intrusiveness of the hoist system 18 relative the animal on which the hoist system 18 used.

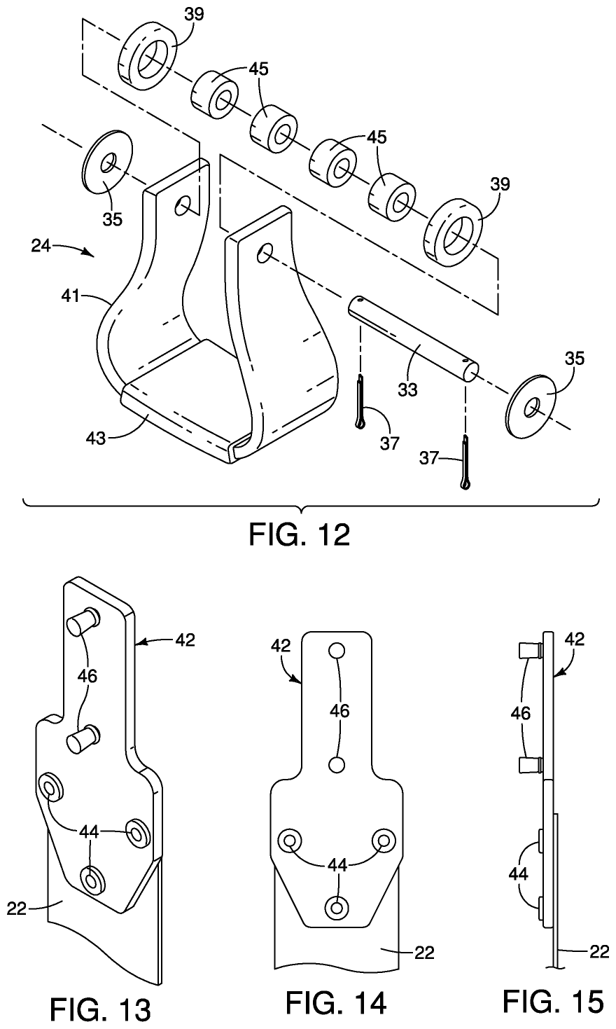

Referring to the exploded view of FIG. 12, and in one embodiment of the invention, stirrup 24 is illustrated having four discrete bearings 45. In one embodiment, hoist system 18 can include a range of one to ten discrete bearings 45. Moreover, if the stirrup 24 is not to be included as a component of the hoist system 18, one or more discrete bearing(s) 45 may, or may not, be included as a component(s) of the hoist system 18.

Referring to FIGS. 13-15, an exemplary billet plate (represented as 42) is illustrated in more detail. It should be understood that the billet plate is the structure of the hoist system 18 that allows the hoist system 18 to be quickly and easily secured to any saddle 12 without modifying or adding structure to the selected saddle (or minimal modifying).

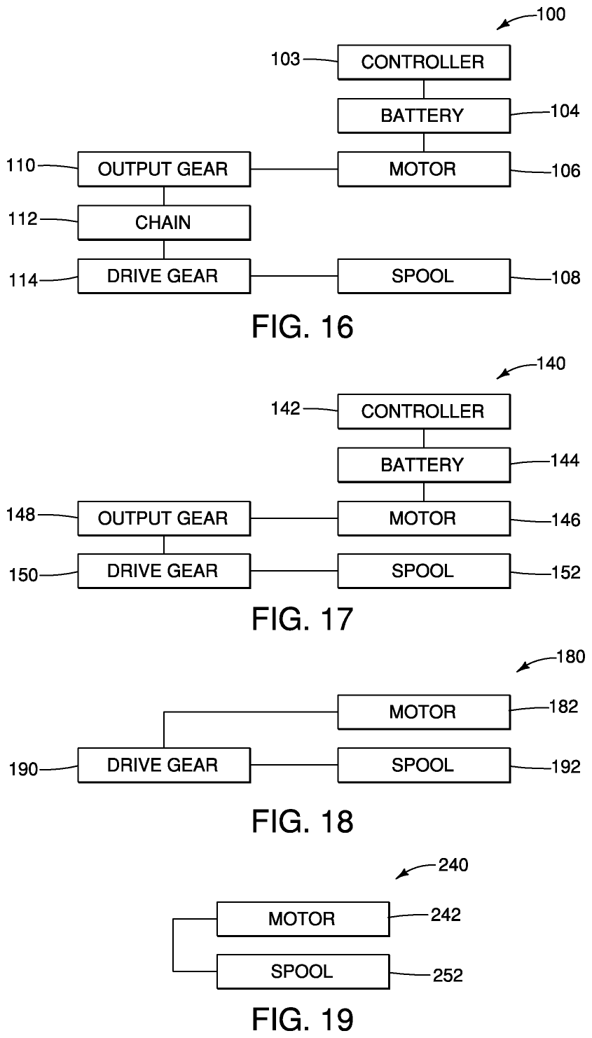

Referring to FIG. 16, a block diagram 100 is illustrated demonstrating the cooperation between components for an exemplary configuration of a hoist system. A controller 103 selectively opens and closes a circuit between a battery 104 and motor 106 to selectively activate, and deactivate, the motor 106. Motor 106 is coupled to an output gear (and/or timing belt pulley or driveshaft) 110. The output gear 110 is coupled to drive gear 114 via chain 112. The drive gear 114 is coupled to spool 108 which selectively winds, and unwinds, a strap to selectively raise and lower a stirrup. Each of the components are discrete structures.

Referring to FIG. 17, a block diagram 140 is illustrated demonstrating the cooperation between components for an exemplary configuration of a hoist system. A controller 142 selectively opens and closes a circuit between the battery 144 and motor 146 to selectively activate, and deactivate, the motor 146. Motor 146 is coupled to an output gear (and/or timing belt pulley or driveshaft) 148 and output gear 148 is directly coupled to drive gear 150 without a chain. As one exemplary non-limiting embodiment of this configuration, the output gear 148 meshes with the drive gear 150. The drive gear 150 is coupled to spool 152 which selectively winds, and unwinds, a strap to selectively raise and lower a stirrup. Each of the components are discrete structures.

Referring to FIG. 18, a block diagram 180 is illustrated demonstrating the cooperation between components for an exemplary configuration of a hoist system. A motor 182 collectively includes a power source and controller in a single unit or structure. The motor 182 is directly coupled to a drive gear 190 (for example, driveshaft to drive gear) and the drive gear 190 is directly coupled to a spool 192. As one exemplary non-limiting embodiment of this configuration, the motor 182 has teeth (or cogs) meshed with the drive gear 190 located on the spool 192. Spool 192 selectively winds, and unwinds, a strap to selectively raise and lower a stirrup.

Referring to FIG. 19, a block diagram 240 is illustrated demonstrating the cooperation between components for an exemplary configuration of a hoist system. A motor 242 collectively has a power source and controller in a single unit or structure. The motor 242 is coupled directly to a spool 252. As one exemplary non-limiting embodiment of this configuration, motor 242 has a driveshaft that is effectively the spool 252. Spool 252 selectively winds, and unwinds, a strap to selectively raise and lower a stirrup.

For any one embodiment of the hoist system disclosed in this document, a range of the total weight for the hoist system is from about 3 lbs. to about 10 lbs. with one specific example being about 5 lbs. For any one embodiment of the hoist system disclosed in this document, a range of time for lifting the stirrup is from about less than 1 second to about 7 seconds with one specific example being about 3 seconds. For any one embodiment of the hoist system disclosed in this document, a range of the lifting-distance capability of the hoist system for the stirrup is from about 10 inches to about 30 inches with one specific embodiment having a lifting range of about 18 inches. It should be understood that the stirrup can begin the lifting/hoisting action at the ground level.

For any one embodiment of a hoist system disclosed in this document, a range of the weight lifting capability of the hoist system is from about 300 pounds to about 500 pounds with one specific embodiment having a weight lifting capability of about 400 pounds. For any one embodiment of the hoist system disclosed in this document, a range of the total time to secure the hoist system to a saddle is from about 2 seconds to about 4 seconds with one specific example being about 3 seconds.

For any one embodiment of a hoist system disclosed in this document, such exemplary hoist system can include one or more of following characteristics, including the controller description below:
1. Compact stirrup hoist for hoisting person onto horse saddle by raising stirrup;
2. Can be mounted on either side of horse;
3. Overall dimensions 2½″×8″×8″ with a range of overall dimensions including (3″-6″)×(8.5″-15″)×(8.5″-15″);
4. Configured with saddle mounting bar that has 2 to 12 tapered nubs that readily mounts to series of holes on saddle belt and can adjust to various heights on saddle. Mounting bar has sliding lock collar to secure connection;
5. 2 second hoisting time with a range of hoisting time being 2 to 24 seconds hoisting time;
6. 18 inches of lift for stirrup, and correspondingly for a person, with a range of lift being from about 6 inches to about 36 inches;
7. 300 lbs. (pounds) initial lift capacity with a range of lift capacity being 300 lbs. to 450 lbs.;
8. 1″ (inch) belt shaft with a range for a belt shaft being ⅓ inch to 6 inches;
9. Automotive seat belt hoisting strap;
10. Single-part hoisting strap to stirrup;
11. The hoist system is light weight of less than 3 lbs. with a range of weights being about 2.5 lbs. to 12 lbs.;
12. High power density hoist system in a compact configuration;
13. Compact controls using brushless electronic speed controllers (ESC) motor control;
14. Upper limit shutoff using miniature Amp. (ampere) limiting control;
15. Small lightweight 24 VDC lithium polymer battery;
16. 8-pole motor developing 35 Amps. (amperes);
17. Planetary gearbox with quiet nonmetal pinion gears;
18. Wireless remote control with small fob;
19. Timing pulley/belt drive system with lightweight aluminum pulleys;
20. Sealed bearings throughout the system;
21. Torque-arm mounted gearmotor that keeps gearbox from supporting overhung load on shaft. Custom machined torque arm that registers on gearbox;
22. Special drive adapter mount that supports two bearings and transfers torque from gearmotor output shaft to drive pulley, with keys to transfer torque from gearbox output shaft to adapter and from adapter to drive pulley;
23. Slotted guides and slide plate bearing mounts for belt tensioning;
24. Two easily removable split couplings on split shaft for quick belt removal/adjustment;
25. High carbon alloy belt shaft machined for split that permits adjustable belt mount;
26. Nylon bushings between moving parts;
27. Snap rings on adapter shaft and belt shaft to retain assembly;
28. Lightweight aluminum alloy, carbon fiber, and high strength injection molded frame construction; and
29. Leather weather-proof cover with flap openings for battery replacement and protection from moving parts.

The one embodiment of the above hoist system disclosed is described in a method of use with a saddle for an animal, particularly a horse. However, any hoist system disclosed in this document can be used in any one of the following exemplary methods of uses:
a) to hoist person into a boat;
b) to hoist person into a truck;
c) to assist in hoisting the elderly out of a seat, bed or toilet;
d) to assist in hoisting the handicapped out of a seat, bed or toilet;
e) as a compact hoist used on construction sites; and
f) as a compact winch for outdoor activities such as camping and 4-wheeling.

In another exemplary non-limiting embodiment of the invention:
The motor is similar to those used on high performance model aircraft and optimized for power density.
General description of an exemplary, non-limiting controller: The controller is specialized for the motor and uses a programmable Electronic Speed Control (ESC) capable of handling a maximum current ranging from 35 A to 100 A, has reverse, has programmable dynamic braking capability in Drag Brake mode. The controller is commanded by a wireless fob approximately 2½×1×⅜ with an up and a down button. The RF receiver receives commands from the fob and provides commands to the electronic speed control for up and down control. The controller has a Current Limiter (unit) that shuts off the motor when the hoisted stirrup or hook reaches end of travel and a current spike is detected. The controller will also stop the motion when the lifting strap binds.
Operational description of an exemplary, non-limiting controller:
   1. The unit passes battery power to the RF receiver.
   2. Upon power, the unit's light emitting diode (LED) will be flashed rapidly and sends a motor-off signal to the Electronic Speed Control (ESC) for 1 second.
   3. The unit will continue to send a motor-off signal to the ESC while it is powered on without a button on the remote being pressed. The LED will be off at this time.
   4. Pressing up or down on the fob:
      A. The unit will throttle up linearly from 0 to 100% over a period of 1 second in the direction that the button was pushed. The LED will be full on.
      B. The unit will throttle down linearly from 100 to 0% over 5 seconds. The LED will remain on.
      C. After 6 seconds the motor will ramp down to a stop and remain stopped until the button is released and pressed again. The LED will be flashing rapidly until the button is released.
      D. If the designated power-limit wattage is reached, the unit will send a stop signal to the ESC and rapidly flash the LED until the button is released.
      E. Releasing the button immediately stops the motor.
   5. The brake strength is adjustable with Castle Link USB dongle and the free downloadable application (Drag Brake setting).
   6. The throttle curve can be adjusted in this application too.
   7. The power of the unit can be set for a range of 440 watts to 940 watts.
   8. There are 4 resistors creating a voltage divider form the RF receiver creating a 1.7 and 3.3 volt signal.
   9. The controller uses the following logic:
      A. <1.1 volts→motor stop
      B. 1.1-2.2 volts→In button, direction A
      C. >2.2 volts→Out button, direction B
   10. As a safety feature, the controller uses a pull-down resister on the input signal lead to stop the motor if a wire breaks.

In compliance with the statute, embodiments of the invention have been described in language more or less specific as to structural and methodical features. It is to be understood, however, that the entire invention is not limited to the specific features and/or embodiments shown and/or described, since the disclosed embodiments comprise forms of putting the invention into effect.

What is claimed is:

1. A stirrup hoist system for hoisting a person onto a saddle comprising:
a motor;
a spool configured to be rotated by the motor;
a strap configured to be selectively rolled on, and selectively rolled off, the spool; and
a support configured to receive a portion of a person's body and slidingly engaging the strap and configured to be selectively moved toward the spool, and selectively moved away from, the spool.

2. The system of claim 1 wherein the motor comprises a rotor, and wherein the spool is directly secured onto the rotor.

3. The system of claim 1 further comprising a chain or timing belt configured to be driven by the motor and rotatably secured to the spool.

4. The system of claim 1 wherein the motor comprises a sprocket or timing belt pulley rotatably engaged with the spool.

5. The system of claim 1 further comprising a drive assembly operatively secured between the motor and the spool.

6. The system of claim 1 wherein the support comprises one of the following: a shoe, stirrup and a boot.

7. The system of claim 1 wherein the strap comprises a first end opposite a second end, the first end secured to the spool.

8. The system of claim 7 wherein the second end of the strap is secured to a saddle.

9. The system of claim 8 wherein the support is a stirrup slidingly engaging one side of the strap between the first and second ends.

10. The system of claim 1 wherein the motor comprises an 8-pole motor capable of developing 35 amperes.

11. The system of claim 1 further comprising a brake system to stop movement of the support.

12. The system of claim 1 further comprising a power source configured to activate the motor.

13. The system of claim 12 wherein the power source comprises a 24 VDC lithium polymer battery.

14. The system of claim 1 further comprising a planetary gearbox operatively coupled between the motor and the spool.

15. The system of claim 14 wherein the planetary gearbox comprises nonmetal pinion gears.

16. A hoist system comprising:
a frame configured to be selectively attached to, and selectively released from, a saddle;
a spool rotatably secured on the frame;
a strap configured to be selectively rolled on, and selectively rolled off, the spool; and
a stirrup slidingly engaging one side of the strap and configured to be selectively moved toward, and selectively moved away from, the saddle.

17. The system of claim 16 further comprising:
a motor secured on the frame and configured to rotate the spool; and
a power source configured to activate the motor.

18. The system of claim 17 wherein the power source comprises a lithium battery.

19. A method for hoisting a person comprising:
providing a strap secured to a saddle and configured to be selectively moved toward, and selectively moved away from, the saddle;
providing a stirrup secured to the strap;
placing a person's foot in the stirrup; and
activating a motor to move the strap and correspondingly move the stirrup.

20. The method of claim 19 further comprising activating a brake system to stop movement of the stirrup.

21. The method of claim 19 further comprising activating an upper limit switch to stop movement of the stirrup at the top of the lift, or when bound up.
